(19) United States
(12) Patent Application Publication
(10) Pub. No.: US 2008/0098862 A1
(43) Pub. Date: May 1, 2008

(54) Hexagonal spanner

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 11/589,508

(22) Filed: Oct. 31, 2006

(51) Int. Cl. B25B 23/10; B25B 23/08

(52) U.S. Cl. 81/451; 81/443

(57) ABSTRACT

A hexagonal spanner has two ends, one end being a long driving end and the other end being a short driving end; the long driving end having a threaded hole for receiving a threaded rod; and the threaded hole being formed near an end portion of the long driving end; two ends of the threaded rod can be engaged to a screw driver; the threaded rod can be driven to protrude from the threaded hole so as to enlarge the size of the long driving end and the long driving end can fit a size of the threaded groove of a screw unit. The threaded hole penetrates through the long driving end. A length of the threaded rod is equal to that of the threaded hole. The short driving end is formed with another threaded hole and another threaded rod is inserted into the threaded hole of the short driving end.

### FIELD OF THE INVENTION

The present invention relates to spanners, and particularly to a hexagonal spanner having a threaded hole and a threaded rod is received in the threaded hole so that the hexagonal spanner can fit an engaging recess of a hexagonal spanner with different size.

### BACKGROUND OF THE INVENTION

The prior art hexagonal spanner has an L shape with a bending portion at a middle section thereof. Two ends of the hexagonal spanner are driving portions. A periphery of each driving portion has a hexagonal shape. The driving portion can be inserted into an engaging recess of a screw unit. The user can drive another end of the hexagonal spanner not being inserted into the engaging recess so as to drive the screw unit to enter into or separate from an object. In general, the size of the driving portion is slightly smaller than that of the engaging recess so that the driving portion can be easily inserted into the engaging recess, but the size of the engaging recess is not fixed, and thus the size of the hexagonal spanner is possible not suited suit for the size of the engaging recess. As a result, the engaging recess will be destroyed.

Accordingly, in one improvement, an end portion of the hexagonal spanner is formed with a tapered section so as to fit the size of the engaging recess. However, this will make the inner wall of the engaging recess round.

In another improvement, one end of the hexagonal spanner is formed with a receiving groove and a steel ball and a spring are installed in the receiving groove. However, in this structure, when the screw unit is driven, the ball will reduce into the engaging recess and thus the screw unit cannot be driven effectively.

### SUMMARY OF THE INVENTION

Accordingly, the primary object of the present invention is to provide a hexagonal spanner having a threaded hole and a threaded rod received in the threaded hole so that the hexagonal spanner can fit an engaging recess of a hexagonal spanner with different size.

To achieve above objects, the present invention provides a hexagonal spanner having two ends, one end being a long driving end and one end being a short driving end; the long driving end having a threaded hole for receiving a threaded rod which has no head; and the threaded hole being formed near an end portion of the long driving end; two ends of the threaded rod can be engaged to a screw driver for driving the threaded rod to rotate; the threaded rod can be driven to protrude from the threaded hole so as to enlarge the size of the lower section of the long driving end and thus the long driving end can fit a size of the engaging recess of a screw unit. The threaded hole penetrates through the long driving end. The threaded hole is at an apex of the hexagonal spanner or a surface of the hexagonal spanner. The orientation of the threaded hole is identical to that of the short driving end. A length of the threaded rod is equal to that of the threaded hole. The short driving end is formed with another threaded hole and another threaded rod is inserted into the threaded hole of the short driving end.

The various objects and advantages of the present invention will be more readily understood from the following detailed description when read in conjunction with the appended drawing.

### BRIEF DESCRIPTION OF THE DRAWINGS

FIG. 1 is a lateral cross sectional view of the hexagonal spanner of the present invention.

FIG. 2 is an assembled schematic view of the hexagonal spanner of the present invention.

FIG. 3 is a lateral cross sectional view showing the use of the present invention.

FIG. 4 is a schematic cross sectional view along line AB of FIG. 3.

FIG. 5 is a lateral cross sectional view showing another application of the present invention.

FIG. 6 is a schematic cross sectional view along line CD of the present invention.

FIG. 7 is a schematic view showing the use of the hexagonal spanner of the present invention.

FIG. 8 is a perspective view showing that in the present invention, the threaded holes can be formed in the long driving end and short driving end.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

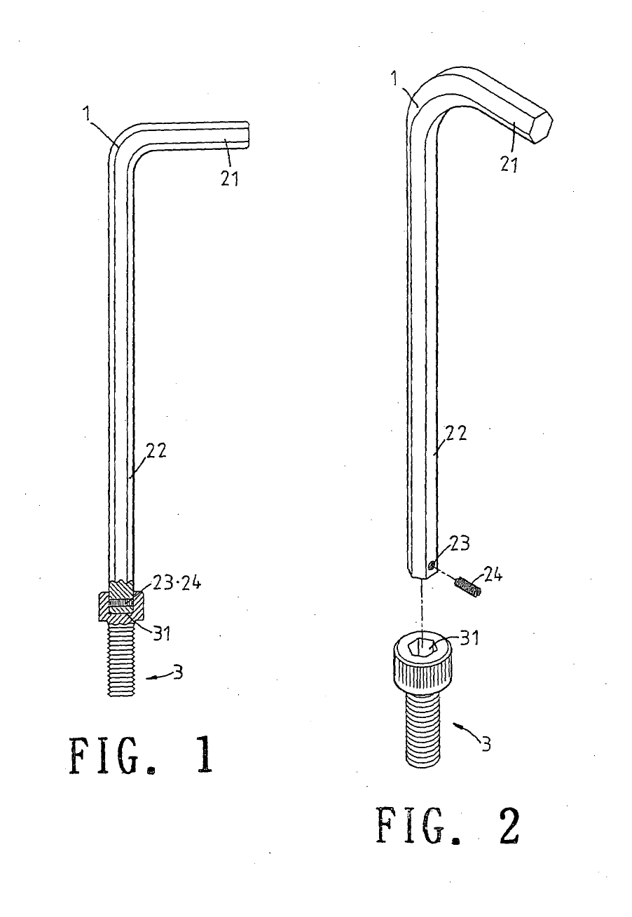

With reference to FIGS. 1 and 2, the hexagonal spanner 1 of the present invention is illustrated. The hexagonal spanner has two ends, one end is a long driving end 22 and the other end is a short driving end 21. The long driving end 22 has a threaded hole 23 radially penetrating therethrough for receiving a threaded rod 24 which has not head.

The threaded hole 23 is formed near an end portion of the long driving end 22 and the orientation of the threaded hole 23 is identical to that of the short driving end 21. A length of the threaded rod 24 is equal to that of the threaded hole 23. Two ends of the threaded rod 24 can be engaged to a screw driver for driving the threaded rod 24 to rotate. The threaded rod 24 can be driven to protrude from the threaded hole 23 so as to enlarge the size of the lower section of the long driving end 22 and thus the long driving end 22 can fit a size of the engaging recess 31.

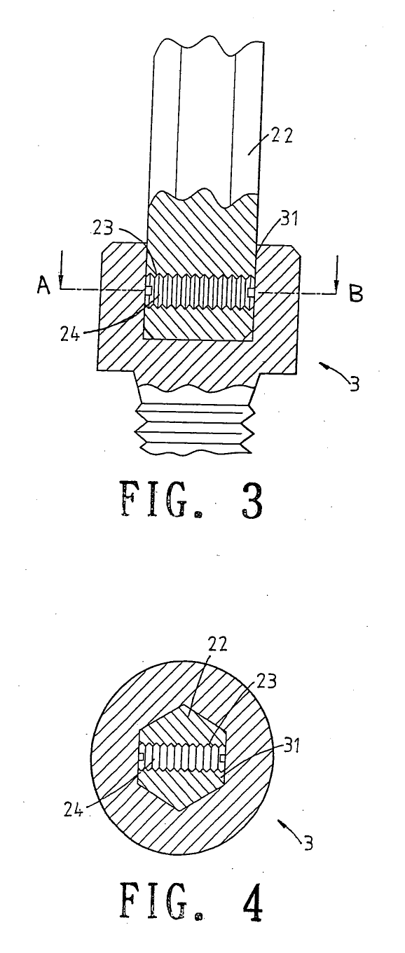

Referring to FIGS. 3 and 4, if the diameter of the long driving end 22 is identical to that of the engaging recess 31, the threaded rod 24 is adjusted to flush with an outer surface of the long driving end 22 without protruding therefrom. Thus, the long driving end 22 can be received in the engaging recess 31.

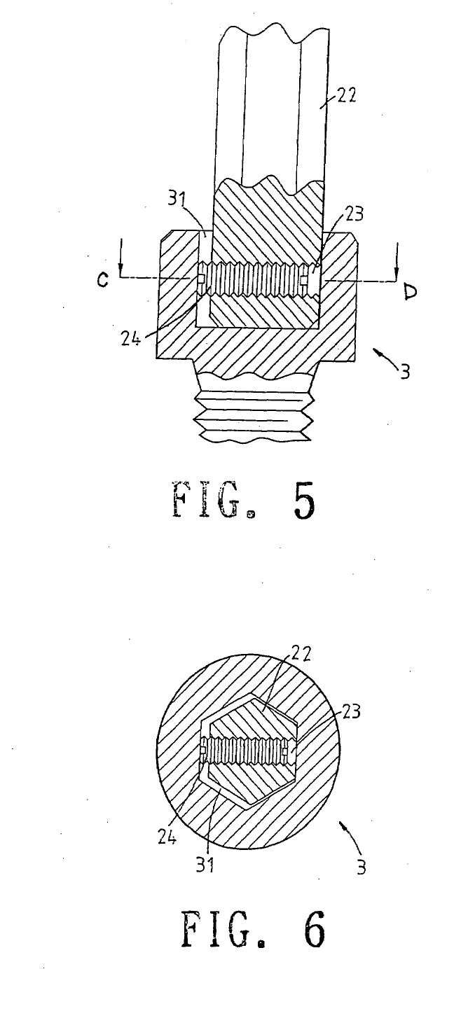

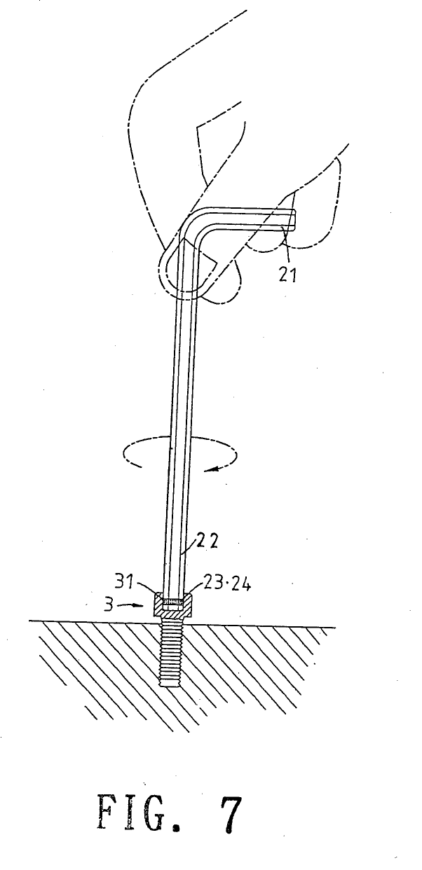

With reference to FIGS. 5 and 7, if the diameter of the long driving end 22 is slightly smaller that of the engaging recess 31. The threaded rod 24 is adjusted to be slightly protruded from a surface of the long driving end 22 so as to resist against the inner wall of the engaging recess 31. Thus the rotation of the screw unit 3 will not destroy the inner hexagonal wall of the engaging recess 31.

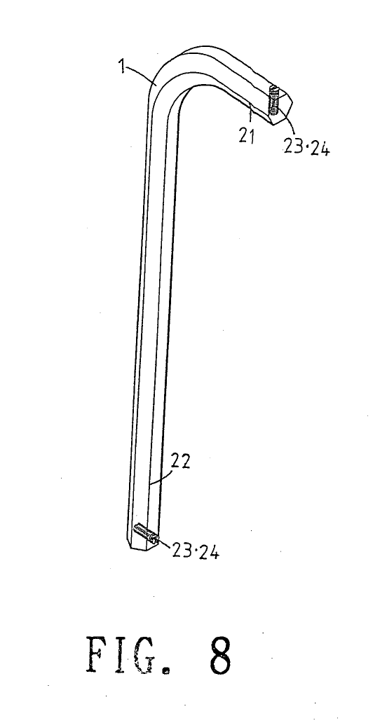

Referring to FIG. 8, in the present invention, a second threaded hole 23 can be formed at the short driving end 21 and a second threaded rod 24 is installed in the threaded hole 23 in the short driving end 21 so that the short driving end 21 or the long driving end 22 can be driven.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hexagonal spanner comprising:
two ends, one end being a long driving end and one end being a short driving end; the long driving end having a threaded hole the threaded hole being formed near an end portion of the long driving end and penetrating through the long driving end axially; no axial slit being formed in the long driving end;
a thread rod received in the threaded hole;
wherein two ends of the threaded rod can be engaged to a screw driver for driving the threaded rod to rotate; the threaded rod can be driven to protrude from the threaded hole so as to enlarge the size of the lower section of the long driving end and thus the long driving end can fit a size of the engaging recess of a screw unit.

2. (canceled)

3. The hexagonal spanner as claimed in claim 1, wherein the threaded hole is opened at an apex of the hexagonal spanner or is opened at a surface of the hexagonal spanner.

4. The hexagonal spanner as claimed in claim 1, wherein a longitudinal axis of the threaded hole is parallel to a longitudinal axis of the short driving end.

5. The hexagonal spanner as claimed in claim 1, wherein a length of the threaded rod is equal to that of the threaded hole.

6. The hexagonal spanner as claimed in claim 1, wherein the short driving end is formed with another threaded hole and another threaded rod is inserted into the threaded hole of the short driving end; and the another threaded hole penetrates through the short driving end axially; no axial slit being formed in the short driving end.
